(19) United States
(12) Patent Application Publication
(10) Pub. No.: US 2025/0053462 A1
(43) Pub. Date: Feb. 13, 2025

(54) DYNAMIC OVERWRITING OF APPLICATION PROGRAMMING INTERFACE OPERATION

(71) Applicant: Capital One Services, LLC, McLean, VA (US)

(72) Inventors: Pedro BETANCOURT, McKinney, TX (US); Mia FREDERICK, The Colony, TX (US); Preetha VEERARAGHAVAN, Plano, TX (US); Johnny NGUYEN, Arlington, TX (US)

(21) Appl. No.: 18/446,330

(22) Filed: Aug. 8, 2023

(51) Int. Cl. G06F 9/54; G06F 8/71

(52) U.S. Cl. CPC G06F 9/54; G06F 8/71

(57) ABSTRACT

In some implementations, a system for application programming interface (API) operation dynamic overwriting may receive an indication, associated with an entity, to overwrite an API operation. The system may receive a user prompt associated with the entity. The system may perform, based at least in part on the user prompt, a set of one or more operations. The API operation may be excluded from the set of the one or more operations based at least in part on the indication to overwrite the API operation being associated with the entity and the user prompt being associated with the entity. The system may provide, based at least in part on performing the set of one or more second operations, a response to the user prompt.

### BACKGROUND

An application program interface (API) is a software intermediary that allows unrelated applications to communicate with each other. For example, the API generally acts like a bridge to take a request or a message from a first application, translate the request or message into a format compatible with a second application and/or perform one or more protocols based on what the API is programmed to do, and then deliver the (translated) request or message to the second application. APIs may use various routines, tools, and/or protocols to specify how different software components and/or applications are to function together.

### SUMMARY

Some implementations described herein relate to a system for API operation dynamic overwriting. The system may include one or more memories and one or more processors communicatively coupled to the one or more memories. The one or more processors may be configured to receive an indication, associated with an entity, to overwrite an API operation. The one or more processors may be configured to receive a user prompt associated with the entity. The one or more processors may be configured to perform, based at least in part on the user prompt, a set of one or more operations. The API operation may be excluded from the set of the one or more operations based at least in part on the indication to overwrite the API operation being associated with the entity and the user prompt being associated with the entity. The one or more processors may be configured to provide, based at least in part on performing the set of the one or more operations, a response to the user prompt.

Some implementations described herein relate to a method for API operation dynamic overwriting. The method may include receiving, by a device, an indication, associated with an entity, to skip an API operation. The method may include receiving, by the device, a user prompt associated with the entity. The method may include skipping, by the device, the API operation based at least in part on the indication to skip the API operation being associated with the entity and the user prompt being associated with the entity. The method may include performing, by the device, based at least in part on the user prompt, a set of one or more operations. The method may include providing, by the device, based at least in part on performing the set of one or more second operations, a response to the user prompt.

Some implementations described herein relate to a non-transitory computer-readable medium that stores a set of instructions. The set of instructions, when executed by one or more processors of a system for API operation dynamic overwriting, may cause the system to receive an indication, associated with an entity, to overwrite an API operation. The set of instructions, when executed by one or more processors of the system, may cause the system to receive a user prompt associated with the entity. The set of instructions, when executed by one or more processors of the system, may cause the system to perform, based at least in part on the user prompt, a set of one or more operations. The API operation may be excluded from the set of the one or more operations based at least in part on the indication to overwrite the API operation being associated with the entity and the user prompt being associated with the entity. The set of instructions, when executed by one or more processors of the system, may cause the API to provide, based at least in part on performing the set of the one or more operations, a response to the user prompt.

### BRIEF DESCRIPTION OF THE DRAWINGS

FIG. 1 is a diagram of an example associated with API operation dynamic overwriting, in accordance with some embodiments of the present disclosure.

FIG. 2 is a diagram of an example associated with a flowchart for dynamically overwriting an API operation, in accordance with some embodiments of the present disclosure.

FIG. 3 is a diagram of an example associated with API operation dynamic overwriting, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of a device associated with API operation dynamic overwriting, in accordance with some embodiments of the present disclosure.

FIG. 6 is a flowchart of an example process associated with dynamic overwriting of API operations, in accordance with some embodiments of the present disclosure.

### DETAILED DESCRIPTION

The following detailed description of example implementations refers to the accompanying drawings. The same reference numbers in different drawings may identify the same or similar elements.

An entity (e.g., a client) may provide data as input to an application software via an application programming interface (API). An API contract for the API may designate fields, which the application software may use to perform an operation, as required or optional. The software may exhibit a default behavior for a certain operation based on one or more optional fields. For example, an API can perform a set of default operations, such as fetching of data, in response to a user prompt. However, an API configured with default operations performs the same default operations for different entities, even if those different entities require different data (e.g., different data types) to satisfy respective user prompts. For example, a first user prompt may require a first set of data or data types, a second user prompt may require a second set of data or data types, and so forth. Thus, APIs that perform the same default operations for all user prompts can overconsume computing resources (e.g., bandwidth, processing resources, or the like) due to fetching of unnecessary data. For example, one or more default operations may return data that is not relevant to respective user prompts. Furthermore, the API may fail to fetch additional data that is necessary to satisfy to the user prompt, which may cause entities to separately configure additional API calls to retrieve the additional data. The additional API calls can further consume computing resources (e.g., bandwidth, processing resources, or the like).

Some implementations described herein enable entities (e.g., clients) to dynamically overwrite default behaviors (e.g., default operations, such as default API calls). In some aspects, an entity may dynamically overwrite, or skip, a default API operation, and the API may refrain from performing that default operation. For example, an API configured to serve multiple entities may receive user prompts from respective entities and perform different sets of operations (e.g., fetch different sets of data or data types) for the respective user prompts. In some aspects, an entity may further provide an indication of data that can be used, instead of the data that was not fetched due to the overwrite, to generate a response to the user prompt.

As a result, techniques described herein may reduce computing resources (e.g., bandwidth, processing resources, or the like) associated with satisfying a user prompt. For example, dynamically overwriting a default operation may enable an API to skip fetching of data that is not relevant for satisfying a user prompt, thereby unburdening computing resources that would otherwise be associated with the fetching of the data. Moreover, providing an indication of data that can be used to generate a response to the user prompt may enable the API to avoid performing additional API operations (e.g., additional API calls), thereby further unburdening computing resources that would otherwise be associated with the additional API calls. Furthermore, while entities with different data requirements may leverage default, “out-of-the-box” behavior (e.g., default operations) when the default behavior matches the data requirements, if one entity has different data requirements, then that entity may have the flexibility to provide an overwrite while permitting other operations (e.g., fetching of other data) to occur. In addition, the default operations and optional overwrites may enable consistency in the API contract, which may avoid configuration of different rules for different entities. Thus, minimal or no changes may be required to the API contract even if one entity has different data requirements than other entities.

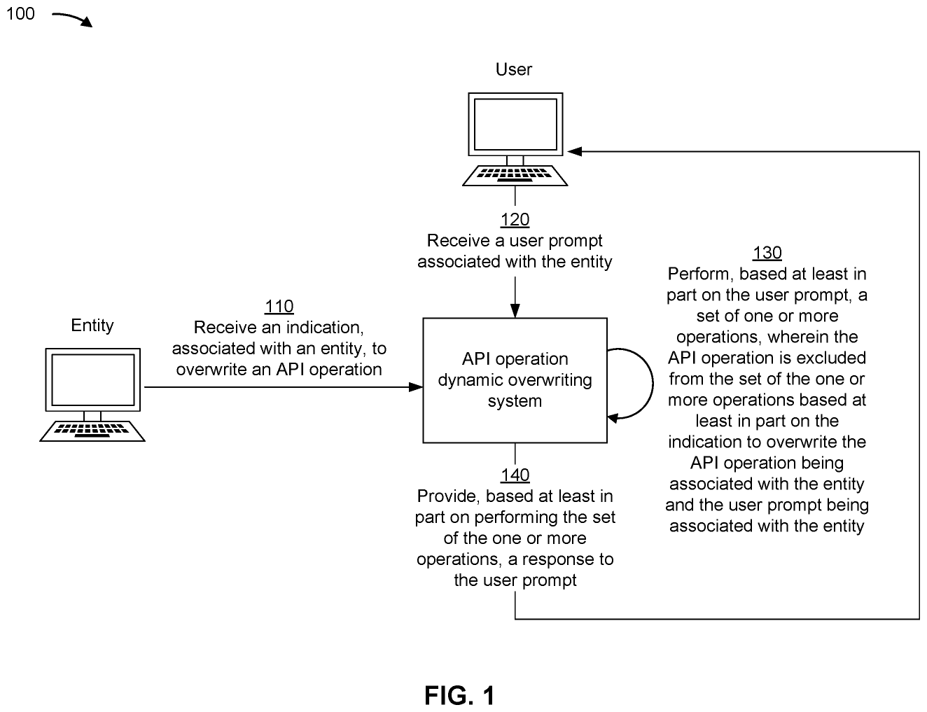

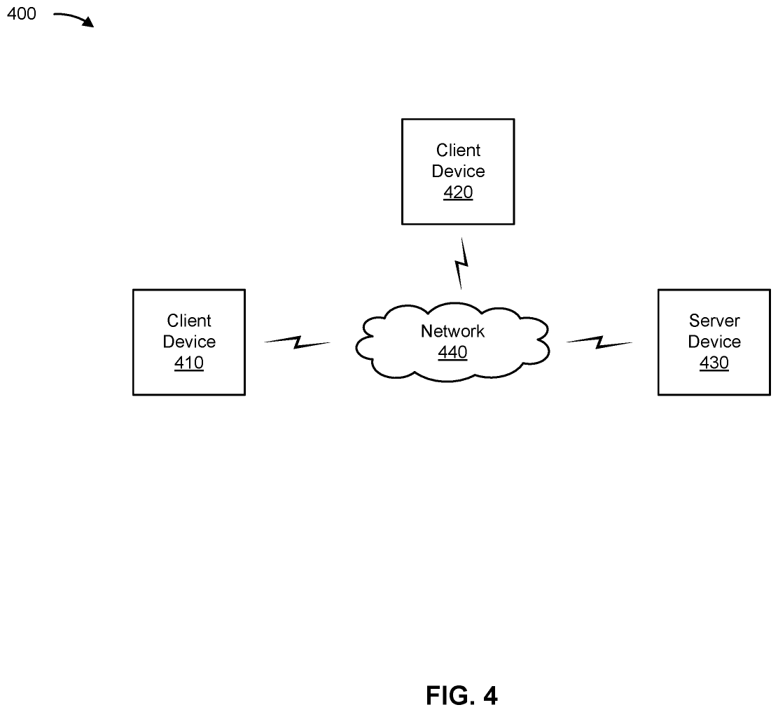

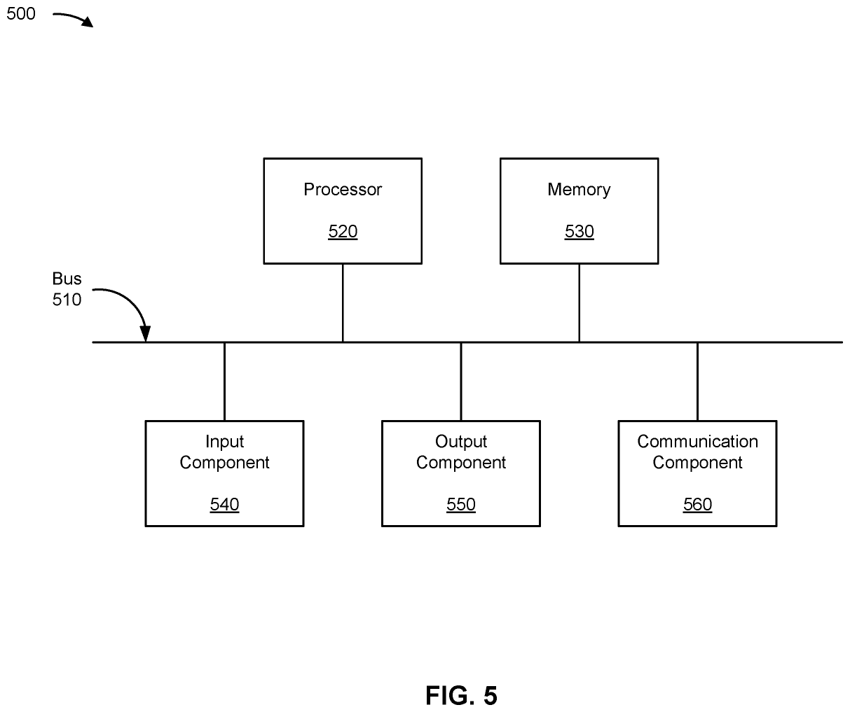

FIG. 1 is a diagram of an example 100 associated with API operation dynamic overwriting. As shown in FIG. 1, example 100 includes a device associated with a user, a device associated with an entity, and an API operation dynamic overwriting system. In some examples, the entity may provide a service through which the user submits a user prompt. These devices are described in more detail in connection with FIGS. 4 and 5.

As shown by reference number 110, the API operation dynamic overwriting system receives an indication, associated with the entity, to overwrite, or skip, an API operation. For example, as shown, the API operation dynamic overwriting system may receive the indication from the entity. The entity may provide the indication at any suitable time (e.g., the indication may be dynamic). In some examples, the API operation may be an API call to fetch data (e.g., data that can be used to generate a response to a user prompt). Thus, the indication may overwrite (e.g., dynamically overwrite) an API call to fetch data. The API operation may be a default API operation (e.g., the API operation dynamic overwriting system may, by default, perform the API operation unless instructed otherwise).

As shown by reference number 120, the API operation dynamic overwriting system receives a user prompt associated with the entity. For example, as shown, the API operation dynamic overwriting system may receive the user prompt from a user. In some examples, the user prompt may trigger the API operation dynamic overwriting system to perform one or more operations. For example, the user prompt may trigger the API operation dynamic overwriting system to perform one or more API calls associated with the entity. In some examples, the user may initiate the user prompt via the entity.

As shown by reference number 130, the API operation dynamic overwriting system performs, based at least in part on the user prompt, a set of one or more operations. In some examples, an API operation may be excluded from the set of one or more operations based at least in part on the indication to overwrite, or skip, the API operation being associated with the entity and the user prompt being associated with the entity. In some examples, the API operation dynamic overwriting system may skip the API operation based at least in part on the indication being associated with the entity and the user prompt being associated with the entity. The API operation may, by default (e.g., without instructions otherwise), be included in the set of the one or more operations. In some examples, the one or more operations may be one or more API calls to fetch data associated with the user prompt. In some examples, the one or more operations may be one or more response generation operations, such as determining a result for a response to the user prompt based on data (e.g., fetched data and/or cached data).

The API operation dynamic overwriting system may overwrite the API operation in response to the indication to overwrite the API operation being associated with the entity and the user prompt being associated with the entity. For example, the API operation dynamic overwriting system may overwrite the API operation based on the API operation dynamic overwriting system having received the indication to overwrite the API operation from the entity and/or based on the API operation dynamic overwriting system having received the user prompt via the entity (e.g., via a website operated by the entity).

As shown by reference number 140, the API operation dynamic overwriting system may provide, based at least in part on performing the set of the one or more API operations, a response to the user prompt. In some examples, the API operation dynamic overwriting system may obtain data using one or more API calls and generate a response based on the data. For example, the response may contain the obtained data and/or may contain a result that is determined based on the data. In some examples, because the API operation was excluded from the set of operation(s), the response may not contain or be based on data that would have been fetched based on the API operation (e.g., the API call).

In some aspects, the API operation dynamic overwriting system may cache data based at least in part on performing the set of the one or more operations. For example, the API operation dynamic overwriting system may cache data retrieved using one or more API calls. In some examples, the API operation dynamic overwriting system may generate another response to a user prompt based on the cached data. The user prompt may be associated with the same user, a different user, the same entity, and/or a different entity.

The API operation being excluded from the set of one or more operations may reduce computing resources (e.g., bandwidth, processing resources, or the like) associated with satisfying the user prompt. For example, dynamically overwriting the API operation may enable the API operation dynamic overwriting system to skip fetching of data that is not relevant for generating the response to the user prompt. As a result, computing resources (e.g., bandwidth, processing resources, or the like) are unoccupied with the first API operation.

Caching data may enable the API operation dynamic overwriting system to further reduce usage of computing resources, such as bandwidth, processing resources, or the like. For example, the API operation dynamic overwriting system may generate a response based on the cached data instead of performing a duplicate API call (e.g., an API call that was used previously to retrieve the data). Thus, the API operation dynamic overwriting system may avoid occupying computing resources with duplicate API calls. Additionally, or alternatively, using cached data may enable the API operation dynamic overwriting system to provide responses faster than the API operation dynamic overwriting system could using API calls to fetch the data.

As indicated above, FIG. 1 is provided as an example. Other examples may differ from what is described with regard to FIG. 1.

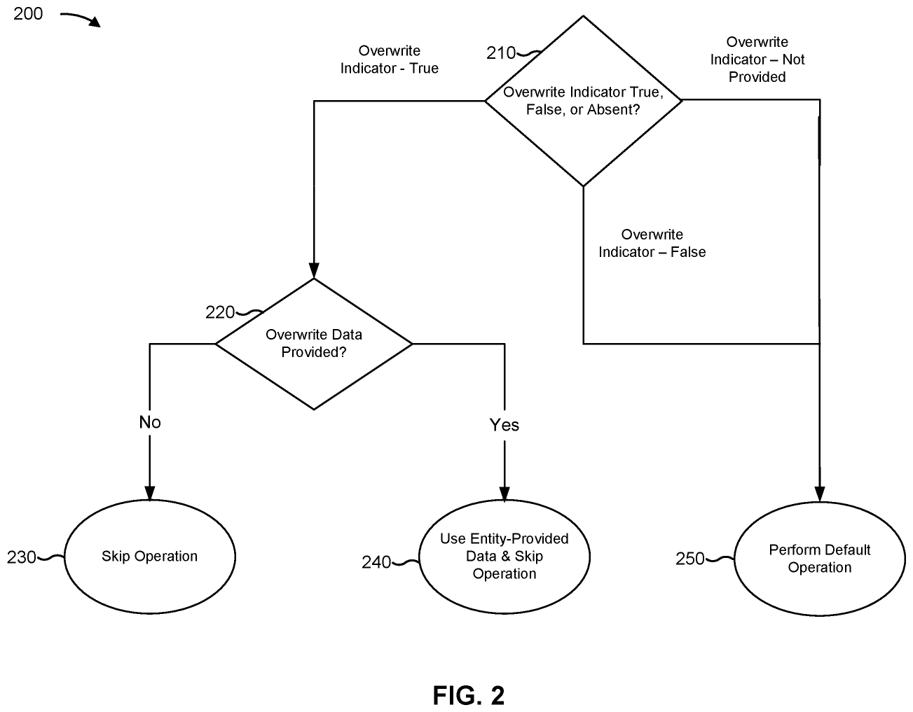

FIG. 2 is a diagram of an example 200 associated with a flowchart for dynamically overwriting an API operation. In example 200, the API operation dynamic overwriting system may receive an indication of whether to overwrite (e.g., skip) an API operation. The indication may, for example, be an overwrite indicator or flag defined by the API.

As shown by reference number 210, the API operation dynamic overwriting system may determine whether the overwrite flag is set to “true,” “false,” or “absent.” In some examples, the overwrite flag is set to true, which may indicate that the API operation dynamic overwriting system is to overwrite or skip the API operation. For example, the entity may pass the overwrite flag as “true” to indicate that the entity intends to overwrite the API operation and, thus, the API operation dynamic overwriting system may skip the (default) API operation upon receiving a user prompt associated with the entity. The overwrite flag set to true may enable the entity to indicate that the API operation dynamic overwriting system is to overwrite or skip the API operation.

As shown by reference number 220, if the overwrite indicator is set to “true,” then the API operation dynamic overwriting system may determine whether an indication, associated with the entity, of data has been received. For example, the data may be overwrite data received from the entity. The API operation dynamic overwriting system may use the indicated data (if any) to generate a response to a user prompt associated with the entity.

In some aspects, no indication, associated with the entity, of data is received. For example, the API operation dynamic overwriting system may determine that no overwrite data has been provided by the entity. In this case, as shown by reference number 230, the API operation dynamic overwriting system may overwrite, or skip, the (default) API operation in accordance with the “true” overwrite indicator being provided. Skipping the API operation when no indication, associated with the entity, of data is received may enable the API operation dynamic overwriting system to behave in a deterministic fashion (e.g., by consistently skipping the API operation regardless of whether overwrite data has been provided).

In some aspects, the API operation dynamic overwriting system may receive an indication, associated with the entity, of the data associated with the entity and provide a response based at least in part on the data. In this case, as shown by reference number 240, the API operation dynamic overwriting system may use entity-provided data and skip the (default) API operation. For example, the API operation dynamic overwriting system may obtain data from the entity and use the entity-provided data (e.g., alone or in combination with other data, such as cached or fetched data) to generate a response to the user prompt. Thus, the API operation dynamic overwriting system (e.g., application software) may use the overwritten data supplied by the entity. Providing a response based at least in part on data associated with the entity may enable the entity to avoid performing additional API operations (e.g., additional API calls) to obtain the data, thereby further unburdening computing resources that would otherwise be occupied with the additional API calls.

As shown by reference number 250, if the overwrite indicator is set to “false,” then the API operation dynamic overwriting system may perform a default API operation. For example, the set of one or more operations performed by the API operation dynamic overwriting system may include at least one API operation, and the API operation dynamic overwriting system may receive at least one indication, associated with the entity, to not overwrite, or to not skip, the at least one API operation. For example, the at least one API operation may be at least one API call to fetch data that the API operation dynamic overwriting system may use to generate a response to the user prompt. As shown in FIG. 2, the at least one indication to not overwrite, or skip, the at least one API operation may be at least one overwrite flag set to false. The at least one indication to not overwrite, or skip, the at least one API operation (e.g., the at least one overwrite flag set to false) may enable the entity to specify that the API operation dynamic overwriting system should perform an API operation (e.g., an API call).

As further shown by reference number 250, if the overwrite indicator is not provided, then the API operation dynamic overwriting system may perform a default API operation. For example, the set of one or more operations performed by the API operation dynamic overwriting system may include at least one API operation, and the API operation dynamic overwriting system may perform the at least one API operation based at least in part on not receiving at least one indication (e.g., overwrite indicator, such as a flag), associated with the entity, to not overwrite, or to not skip, the at least one API operation. Thus, if the indicator flag is not passed by the entity, then the API operation dynamic overwriting system may perform the at least one API operation (e.g., a default API operation) as though an indicator flag associated with the at least one API operation were set to false. For example, the API may define a set of optional data (e.g., an indicator flag) correlated with a particular operation, and when a user prompt initiates a transaction via the API, if the optional data is absent, the application software may perform default behavior (e.g., an API call) and return the results in the response to the user prompt. Performing the at least one API operation based at least in part on not receiving the at least one indication may help to ensure that the API operation dynamic overwriting system fetches data to respond to a user prompt in the absence of an indication of whether to skip the API operation.

As indicated above, FIG. 2 is provided as an example. Other examples may differ from what is described with regard to FIG. 2.

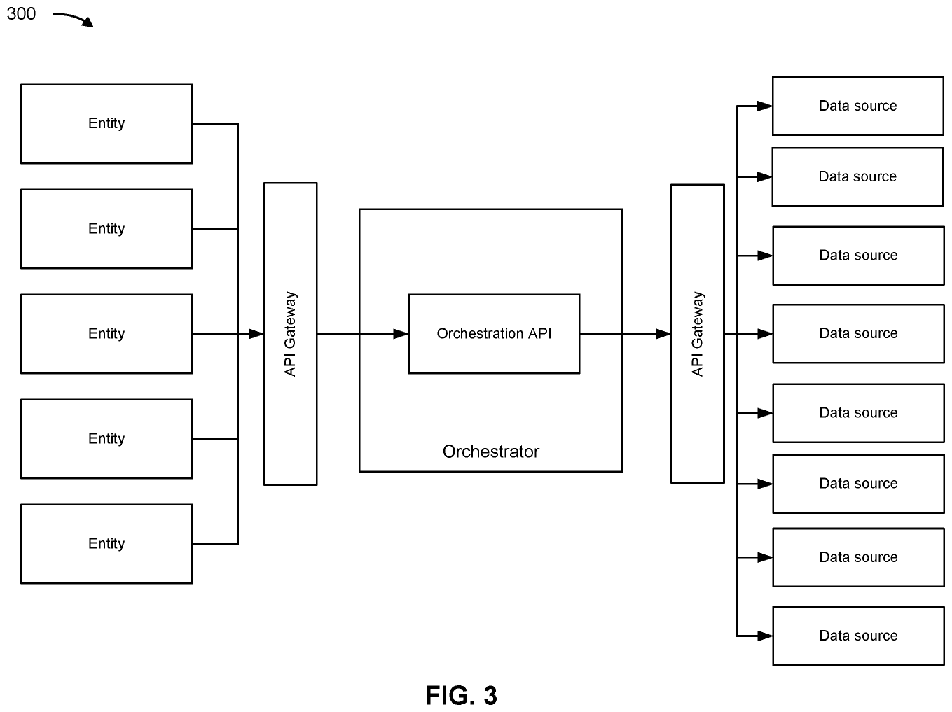

FIG. 3 is a diagram of an example 300 associated with API operation dynamic overwriting.

As shown in FIG. 3, an orchestrator (e.g., the API operation dynamic overwriting system) may include an orchestration API (e.g., the API described herein). The orchestrator may obtain one or more user prompts, via an API gateway (e.g., via an internal API gateway, such as by using a hyperlink), from one or more entities (e.g., clients, marketplaces, websites, or the like). In response to the user prompt(s), the orchestration API may perform one or more API calls to fetch data, via an API gateway (e.g., via an internal API gateway, such as by using a hyperlink), from one or more data sources. The orchestrator may generate one or more responses to the user prompt(s) based on the fetched data and provide the response(s) to the one or more user prompts.

In some aspects, a user prompt may relate to an exchange involving a vehicle (e.g., financing, leasing, or the like). For example, the orchestrator may be a transaction aggregation and calculation tool that serves entities to allow users to structure a transaction involving a vehicle. For example, the orchestrator may receive a user prompt, via an entity (e.g., via a vehicle dealership website), may include adjustable user input data (e.g., target down payment, target term length, or the like) and obtain transaction data (e.g., dealer fees, tax, title, and license (TTL) fees, or the like) from the data sources via the orchestration API. The orchestrator may aggregate the transaction data and combine the aggregated transaction data with the adjustable user input data to generate a response to the user prompt. For example, the response may include an indication of a monthly transaction quantity relating to the vehicle (e.g., a monthly payment).

In some aspects, an entity may provide an indication to overwrite, or skip, an API operation (e.g., an API operation that the orchestrator performs by default). For example, based on the indication, the orchestration API may refrain from fetching data from one or more of the data sources. In some aspects, the orchestrator may also receive an indication, associated with an entity, of data, and the orchestrator may provide a response to a user prompt based at least in part on the data.

In some examples, the orchestrator may perform at least a first default API operation involving fetching dealer fee data from a dealer settings system and a second default API operation involving fetching TTL data from a third-party vendor. The orchestrator may, by default, apply this data to generate a response to a user prompt. However, the entity may prioritize different data sources (e.g., different vendors/solutions) for the dealer fee data and/or for the TTL data. Accordingly, the API may provide two input flags as part of the API contract (e.g., “isDealerFeesOverriden” and “isTTLFeesOverriden”) as well the object structure for retrieval associated with the API operation, and the entity may use the input flags to indicate that the dealer fee data and/or the TTL data are to be overwritten.

In some aspects, the indication is a JavaScript object notation (JSON) payload. An example JSON payload is provided as follows.

| { | |
|---|---|
| “isDealerFeesOverridden”: true, | |
| “isTTLFeesOverridden”: true, | |
| “fees”: | [ |

{

“amount”: 300,
“feeType”: “DEALER”

```
    },
    {
```

“amount”: 1500,
“feeType”: “TAX_TITLE_LICENSE”

```
    }
  ]
}
```

In this example, the JSON payload skips default API operations associated with fetching the dealer fees and TTL fees and provides entity-specific dealer and TTL fees.

As indicated above, FIG. 3 is provided as an example. Other examples may differ from what is described with regard to FIG. 3.

FIG. 4 is a diagram of an example environment 400 in which systems and/or methods described herein may be implemented. As shown in FIG. 4, environment 400 may include a client device 410, a client device 420, a server device 430, and a network 440. Devices of environment 400 may interconnect via wired connections, wireless connections, or a combination of wired and wireless connections.

The client device 410 may include one or more devices capable of receiving, generating, storing, processing, and/or providing information associated with dynamic overwriting of API operations, as described elsewhere herein. For example, the client device 410 may be associated with an entity. The client device 410 may include a communication device and/or a computing device. For example, the client device 410 may include a wireless communication device, a mobile phone, a user equipment, a laptop computer, a tablet computer, a desktop computer, or a similar type of device.

The client device 420 may include one or more devices capable of receiving, generating, storing, processing, and/or providing information associated with dynamic overwriting of API operations, as described elsewhere herein. For example, the client device 410 may be associated with a user (e.g., an end user). The client device 420 may include a communication device and/or a computing device. For example, the client device 420 may include a wireless communication device, a mobile phone, a user equipment, a laptop computer, a tablet computer, a desktop computer, or a similar type of device.

The server device 430 may include one or more devices capable of receiving, generating, storing, processing, providing, and/or routing information associated with dynamic overwriting of API operations, as described elsewhere herein. For example, the server device 430 may host the API operation dynamic overwriting system. The server device 430 may include a communication device and/or a computing device. For example, the server device 430 may include a server, such as an application server, a client server, a web server, a database server, a host server, a proxy server, a virtual server (e.g., executing on computing hardware), or a server in a cloud computing system. In some implementations, the server device 430 may include computing hardware used in a cloud computing environment.

The network 440 may include one or more wired and/or wireless networks. For example, the network 440 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 440 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500 associated with API operation dynamic overwriting. The device 500 may correspond to server device 430. In some implementations, server device 430 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

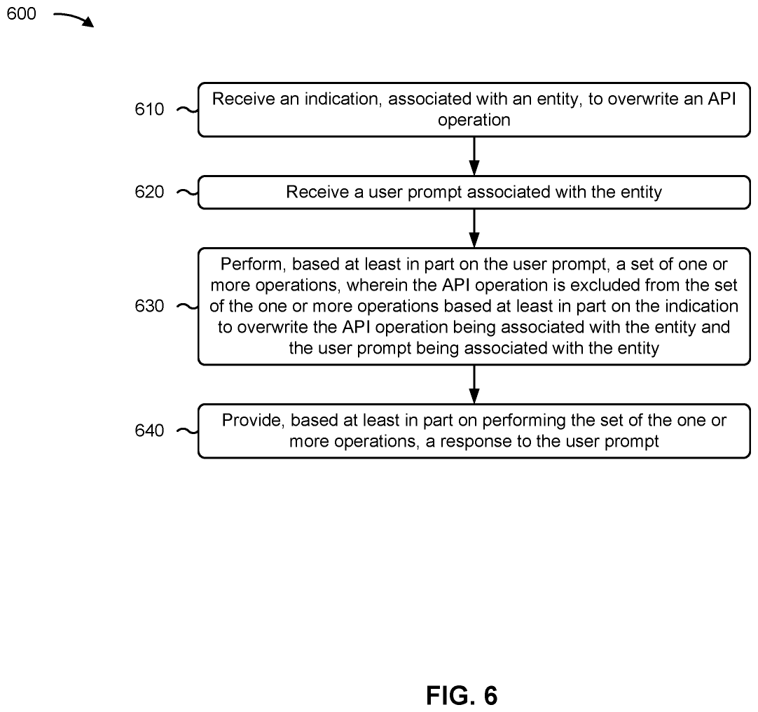

FIG. 6 is a flowchart of an example process 600 associated with dynamic overwriting of API operations. In some implementations, one or more process blocks of FIG. 6 may be performed by the server device 430. In some implementations, one or more process blocks of FIG. 6 may be performed by another device or a group of devices separate from or including the server device 430, such as the client device 410, the client device 420, and the network 440. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving an indication, associated with an entity, to overwrite an API operation (block 610). For example, the server device 430 (e.g., using processor 520, memory 530, input component 540, and/or communication component 560) may receive an indication, associated with an entity, to overwrite an API operation, as described above in connection with reference number 110 of FIG. 1. As an example, the server device 430 may receive, from an entity, an indication to skip a default API operation, such as an API call.

As further shown in FIG. 6, process 600 may include receiving a user prompt associated with the entity (block 620). For example, the server device 430 (e.g., using processor 520, memory 530, input component 540, and/or communication component 560) may receive a user prompt associated with the entity, as described above in connection with reference number 120 of FIG. 1. As an example, the server device 430 may receive a user prompt that would, by default, trigger the server device 430 to perform the default API operation.

As further shown in FIG. 6, process 600 may include performing, based at least in part on the user prompt, a set of one or more operations, wherein the API operation is excluded from the set of the one or more operations based at least in part on the indication to overwrite the API operation being associated with the entity and the user prompt being associated with the entity (block 630). For example, the server device 430 (e.g., using processor 520 and/or memory 530) may perform, based at least in part on the user prompt, a set of one or more operations, as described above in connection with reference number 130 of FIG. 1. In some implementations, the API operation is excluded from the set of the one or more operations based at least in part on the indication to overwrite the API operation being associated with the entity and the user prompt being associated with the entity. As an example, the server device 430 may perform the set of one or more operations and skip the default API operation.

As further shown in FIG. 6, process 600 may include providing, based at least in part on performing the set of the one or more operations, a response to the user prompt (block 640). For example, the server device 430 (e.g., using processor 520 and/or memory 530) may provide, based at least in part on performing the set of the one or more operations, a response to the user prompt, as described above in connection with reference number 140 of FIG. 1. As an example, the server device 430 may generate the response based on the set of the one or more operations and not based on the default API operation.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1-3. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having.” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for application programming interface (API) operation dynamic overwriting, the system comprising:
one or more memories; and
one or more processors, communicatively coupled to the one or more memories, configured to:
receive an indication, associated with an entity, to overwrite an API operation;
receive a user prompt associated with the entity;
perform, based at least in part on the user prompt, a set of one or more operations,
wherein the API operation is excluded from the set of the one or more operations based at least in part on the indication to overwrite the API operation being associated with the entity and the user prompt being associated with the entity; and
provide, based at least in part on performing the set of the one or more operations, a response to the user prompt.

2. The system of claim 1, wherein the indication to overwrite the API operation is an overwrite flag set to true.

3. The system of claim 1, wherein no indication, associated with the entity, of data is received.

4. The system of claim 1, wherein the one or more processors are further configured to:
receive an indication, associated with the entity, of data,
wherein the one or more processors, to provide the response, are configured to provide the response based at least in part on the data.

5. The system of claim 1, wherein the API operation is a first API operation, wherein the set of one or more operations includes at least one second API operation, and wherein the one or more processors are further configured to:
receive at least one indication, associated with the entity, to not overwrite the at least one second API operation.

6. The system of claim 5, wherein the at least one indication to not overwrite the at least one second API operation is at least one overwrite flag set to false.

7. The system of claim 1, wherein the API operation is a first API operation, and wherein the set of one or more operations includes at least one second API operation, and wherein the one or more processors, to perform the at least one second API operation, are configured to:
perform the at least one second API operation based at least in part on not receiving at least one indication, associated with the entity, to not overwrite the at least one second API operation.

8. The system of claim 1, wherein the one or more processors are further configured to:
cache data associated with the response.

9. A method for application programming interface (API) operation dynamic overwriting, comprising:
receiving, by a device, an indication, associated with an entity, to skip an API operation;
receiving, by the device, a user prompt associated with the entity;
skipping, by the device, the API operation based at least in part on the indication to skip the API operation being associated with the entity and the user prompt being associated with the entity;
performing, by the device, based at least in part on the user prompt, a set of one or more operations; and
providing, by the device, based at least in part on performing the set of one or more second operations, a response to the user prompt.

10. The method of claim 9, wherein the indication to skip the API operation is an overwrite flag set to true.

11. The method of claim 9, wherein no indication, associated with the entity, of data is received.

12. The method of claim 9, further comprising:
receiving, by the device, an indication, associated with the entity, of data,
wherein providing the response includes providing the response based at least in part on the data.

13. The method of claim 9, wherein the API operation is a first API operation, and wherein the set of one or more operations includes at least one second API operation, the method further comprising:
receiving, by the device, at least one indication, associated with the entity, to not skip the at least one second API operation.

14. The method of claim 9, wherein the API operation is a first API operation, and wherein the set of one or more operations includes at least one second API operation, and wherein performing the at least one second API operation includes:
performing the at least one second API operation based at least in part on not receiving one or more indications, associated with the entity, to not skip the at least one second API operation.

15. The method of claim 9, wherein the indication to skip the API operation is a JavaScript object notation (JSON) payload.

16. The method of claim 9, wherein the user prompt relates to an exchange involving a vehicle.

17. A non-transitory computer-readable medium storing a set of instructions, the set of instructions comprising:
one or more instructions that, when executed by one or more processors of a system for application programming interface (API) operation dynamic overwriting, cause the system to:
receive an indication, associated with an entity, to overwrite an API operation;
receive a user prompt associated with the entity;
perform, based at least in part on the user prompt, a set of one or more operations,
wherein the API operation is excluded from the set of the one or more operations based at least in part on the indication to overwrite the API operation being associated with the entity and the user prompt being associated with the entity; and
provide, based at least in part on performing the set of the one or more operations, a response to the user prompt.

18. The non-transitory computer-readable medium of claim 17, wherein the API operation is an API call to fetch data.

19. The non-transitory computer-readable medium of claim 17, wherein the indication to overwrite the API operation is a JavaScript object notation (JSON) payload.

20. The non-transitory computer-readable medium of claim 17, wherein the user prompt relates to an exchange involving a vehicle.
